(19) United States
(12) Patent Application Publication
(10) Pub. No.: US 2002/0006804 A1
(43) Pub. Date: Jan. 17, 2002

(54) Communication terminal and communication system

(76) Inventors: Hiromu Mukai, Osaka (JP); Hitoshi Hagimori, Osaka (JP); Minoru Kuwana, Osaka (JP); Tsutomu Honda, Osaka (JP); Kazuhiko Ishimaru, Osaka (JP); Hideki Nagata, Osaka (JP)

Correspondence Address: Barry E. Bretschneider, Morrison & Foerster LLP, Suite 550, 2000 Pennsylvania Avenue, N.W., Washington, DC, 20006-1888, US

(21) Appl. No.: 09/901,008

(22) Filed: Jul. 10, 2001

(30) Foreign Application Priority Data
Jul. 12, 2000 (JP) 2000-211367
Jul. 12, 2000 (JP) 2000-211523

(51) Int. Cl. H04B 7/00

(52) U.S. Cl. 455/518; 455/520; 455/566

(57) ABSTRACT

A communication terminal is provided with a line establishing means which establishes lines to a plurality of different terminals on the other side in parallel with each other. Moreover, the communication terminal is provided with a microphone through which voice is inputted, and a communication control means for transmitting voice inputted through the microphone to a plurality of different terminals on the other side. Thus, it is possible to simultaneously transmit the voice to a plurality of partners. Furthermore, the communication control means can receive voices transmitted from a plurality of difference terminals on the other side, and since the voices received by the communication control means are outputted from a speaker, it is possible to carry out conversations among a plurality of users at the same time.

This application is based on application Nos. 2000-211367 and 2000-211523 filed in Japan, the contents of which are hereby incorporated by reference.

### BACKGROUND OF THE INVENTION

1. Field of the Invention

The present invention relates to a construction of a communication terminal that enables telephone conversations with a plurality of partners, and also concerns constructions of various systems using such a communication terminal.

2. Description of the Background Art

For example, there are communication terminals, such as mobile telephones and fixed-type telephones, that enable conversations by voice. In these communication terminals, in the case when a normal conversation between two users is carried out, a one-to-one communication terminal is established between the two communication terminals. Therefore, it is a basic idea that the one-to-one conversation is established.

Moreover, there are communication systems that enable simultaneous conversations among a plurality of users. Each of these conversation systems is provided by a network (telephone line) service company as its center service, and a central station within the center establishes lines among a plurality of communication terminals.

FIG. 33 shows a construction of such a conversation system joined by a plurality of users that is provided by the network service company. Here, each of the terminals has a structure in which one communication line is exclusively used, and in this system, each of the plurality of terminals establishes a line to the central station individually.

By utilizing the communication system of this type, a plurality of friends, etc., can enjoy simultaneous conversations, even when they are far apart from each other. Moreover, conventionally, by utilizing such a conversation system, a telephone conference system has been realized, and for example, a telephone conference can be simultaneously carried out among a main office, an A branch office and a B branch office of one company, which are located geographically apart from each other.

However, in the above-mentioned conversation system joined by a plurality of users, it is necessary for the users to preliminarily join the service in order to utilize the service. In other words, they need to preliminarily apply for a registration in the network service company so as to utilize the conversation service joined by a plurality of users, and only among the registered members, simultaneous conversations are available.

For this reason, although this system meets users' demands for conversations among a limited group or regular conferences within a company, it is not suitable for demands for conversations joined by a plurality of people from various groups.

Moreover, by joining the conversation system joined by a plurality of users, it is possible to enjoy conversations among the participants and to carry out a telephone conference; however, since this conversation system is dependent on the system on the network center side as described above, it is not possible for each of the participants on the terminal side to control the service modes. In other words, each of the participants is only allowed to carry out a control operation as to whether or not he or she joins the conversation system joined by a plurality of people (whether or not a line should be established), and is not allowed to carry out further operations; consequently, they are only allowed to use the service modes in a limited manner.

Moreover, in the case when there are a plurality of partners joining conversations, it is sometimes difficult to discern which partner is currently having a conversation. In other words, since voices transmitted from a plurality of conversation ends are outputted from a single speaker, it is sometimes difficult to recognize the switching of the currently speaking partner. In particular, in the case when partners having similar voices are included in the partners joining conversation, or in the case when conversations are carried out among group members that are not acquainted with each other, the system is more susceptible to a confusion, failing to fully achieve advantages of the conversation system joined by a plurality of users.

Furthermore, as described above, since the conversation system joined by a plurality of users is dependent on the system on the network center side, it is not possible to install a means for discriminating the transmission end of voice on the terminal side. In other words, with a single line being established to the network center, a plurality of voices are transmitted, with the result that it is impossible for the terminal side to discriminate transmission ends of the respective voices.

### SUMMARY OF THE INVENTION

This invention is directed to a communication terminal that enables telephone conversations by voice.

In accordance with the present invention, a communication terminal comprises: a microphone through which voice is inputted; a line establishing element that can establish lines to a plurality of terminals on the other side in parallel with each other; a communication control element for transmitting voice inputted through the microphone to the plurality of terminals on the other side, and for receiving voice transmitted from the plurality of terminals on the other side; and a speaker for outputting voice received by the communication control element.

In accordance with the present invention, it becomes possible to have simultaneous conversations with a plurality of users on the other side.

In one aspect of the present invention, the communication terminal comprises: an origination information receiving element for receiving origination information data for another communication terminal A that is not having conversations with the terminal in question from still another communication terminal B that is currently having conversations with the terminal in question; and a line automatic establishing element which, in response to the receipt of the origination information data, establishes a line to the communication terminal A without terminating the line to the receiving terminal B.

Thus, it is possible to realize line establishments to a plurality of terminals by using a simple operation.

In another aspect of the present invention, the communication terminal comprises: an origination information generating element for generating origination information data for another communication terminal C; and an origination information transmitting element for transmitting the origination information data for the communication terminal C, generated by the origination information generating element, to another communication terminal B that is having conversations with the terminal in question, but is not having conversations with the communication terminal C.

Consequently, it is possible to realize line establishments to a plurality of terminals by using a simple operation.

The present invention is also directed to a conversation system that enables conversations by voice among a plurality of communication terminals.

In accordance with this invention, in this conversation system, at least one communication terminal among the plurality of communication terminals comprise: a microphone through which voice is inputted; a line establishing element that can establish lines to a plurality of terminals on the other side in parallel with each other; a communication control element for transmitting voice inputted through the microphone to the plurality of terminals on the other side, and for receiving voice transmitted from the plurality of terminals on the other side; and a speaker for outputting voice received by the communication control element.

This invention enables simultaneous conversations joined by a plurality of users, thereby making it possible to provide various services.

Thus, the objective of the present invention is to provide a communication terminal that is superior in the operability and that enables conversations joined by a plurality of users, and also to add various service modes to the conversation system joined by a plurality of users.

These and other objects, features, aspects and advantages of the present invention will become more apparent from the following detailed description of the present invention when taken in conjunction with the accompanying drawings.

### DESCRIPTION OF THE DRAWINGS

FIG. 1 is a drawing that shows a construction of a communication terminal in accordance with a first preferred embodiment;

FIG. 2 is a drawing that shows a construction of a conversation system that is achieved between the communication terminal of the first preferred embodiment and conventional terminals;

FIG. 3 is a drawing that shows a construction of a conversation system that is achieved by utilizing a plurality of the communication terminals of the first preferred embodiment;

FIG. 4 is a drawing that shows an automatic establishing process of a communication line;

FIG. 5 is a drawing that also shows an automatic establishing process of a communication line;

FIGS. 6A, 6B and 6C are drawings that show the display contents of a monitor of each of the communication terminals during conversations by a plurality of users;

FIGS. 7A and 7B are drawings that show a construction of a communication terminal provided with a secret conversation mode;

FIG. 8 is a drawing that shows a state during the secret conversation mode;

FIG. 9 is a drawing that shows a flow of voice and a flow of excluded information at the time when the secret mode comes on;

FIG. 10 is a drawing that shows a flow of voice at the time of an assisting mode;

FIGS. 11A, 11B and 11C are drawings that show the display contents of the monitor at the time when a conversation mode by a plurality of users comes on;

FIGS. 12A, 12B and 12C are drawings that show the display contents of the monitor at the time when an assisting mode comes on;

FIG. 13 is a drawing that shows a construction of a conversation system joined by a plurality of users (6 users);

FIG. 14 is a perspective view showing a state in which a communication terminal (mobile telephone) in accordance with a second preferred embodiment is placed longitudinally;

FIG. 15 is a perspective view showing a state in which the communication terminal (mobile telephone) is placed laterally;

FIG. 16 is a drawing that shows an inner construction of a mobile telephone in accordance with the second preferred embodiment;

FIG. 17 is a drawing that shows a process flow of a transmission end identifying means;

FIG. 18 is a drawing that shows a state in which a list of dial numbers is displayed on the monitor;

FIG. 19 is a drawing that shows a state in which a dial number related to a terminal that is currently transmitting voice is displayed in thicker characters;

FIG. 20 is a drawing that shows a state in which the dial number related to the terminal that is currently transmitting voice is given as a meshed display;

FIG. 21 is a drawing that shows a state in which the dial number related to the terminal that is currently transmitting voice is displayed with an outer frame given thereto;

FIG. 22 is a drawing that shows a state in which the dial number related to the terminal that is currently transmitting voice is displayed in a relatively larger size;

FIG. 23 is a drawing that shows a state in which the display area of the monitor is divided into division areas in which images received from transmission ends are displayed;

FIG. 24 is a drawing that shows a state in which the area frame of the division area related to the terminal that is currently transmitting voice is highlighted;

FIG. 25 is a drawing that shows a state in which the division area related to the terminal that is currently transmitting voice is displayed relatively with an increase in luminance;

FIG. 26 is a drawing that shows a state in which the division area related to the terminal that is currently transmitting voice is displayed relatively in a larger size;

FIG. 27 is a drawing that shows a state in which a dial number is displayed on the division area in place of the image;

FIG. 28 is a drawing that shows a display example of a monitor in the case when a plurality of images are received from the same terminal;

FIG. 29 is a drawing that shows another preferred embodiment in which two speakers are attached to the mobile telephone;

FIG. 30 is a drawing that shows still another preferred embodiment in which the two speakers are shifted apart from each other longitudinally;

FIG. 31 is a drawing that shows the other preferred embodiment in which four speakers are attached to the mobile telephone;

FIG. 32 is a drawing that shows the inner construction of the mobile telephone having the two speakers; and

FIG. 33 is a drawing that shows a conventional conversation system joined by a plurality of users.

### DESCRIPTION OF THE PREFERRED EMBODIMENTS

### First Preferred Embodiment

<1. Communication Terminal Capable of Simultaneously Establishing a Plurality of Communication Lines>

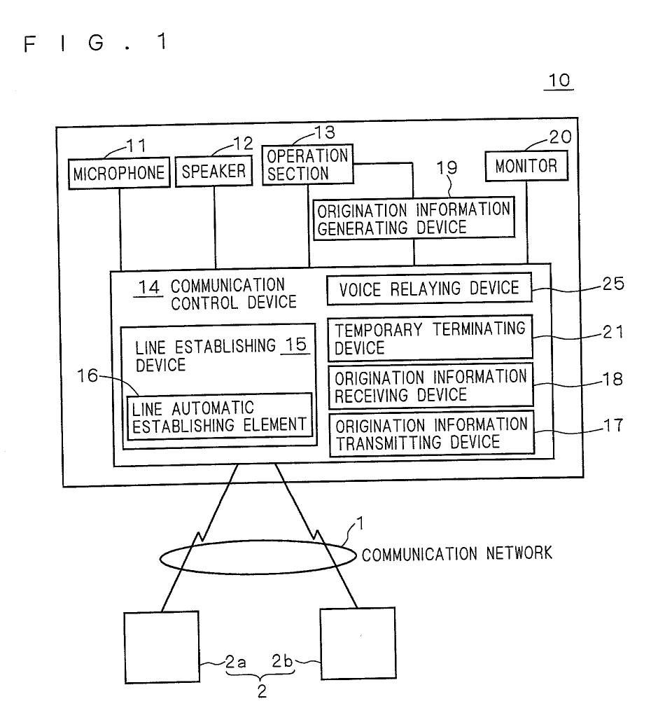

Referring to Figures, the following description will discuss a first preferred embodiment of the present invention. First, an explanation will be given of a preferred embodiment of a communication terminal 10 by reference to FIG. 1. This communication terminal 10 is a terminal that enables voice conversations; and not particularly limited, examples thereof include a home-use fixed telephone, a mobile telephone and a business telephone used in an office, or a personal digital assistance to which a voice conversation function is added.

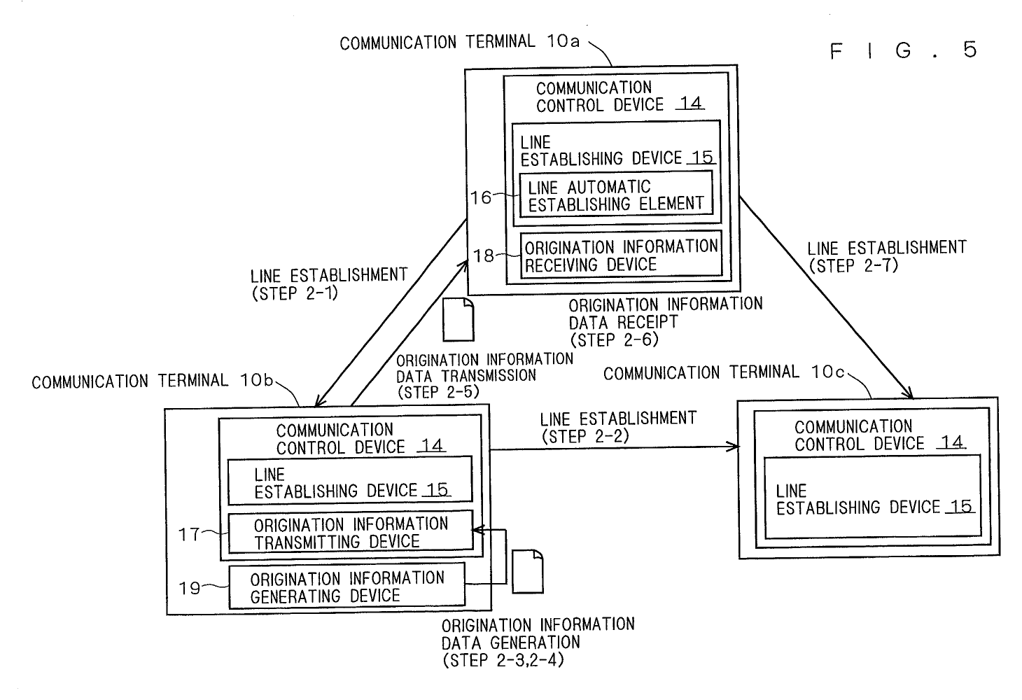

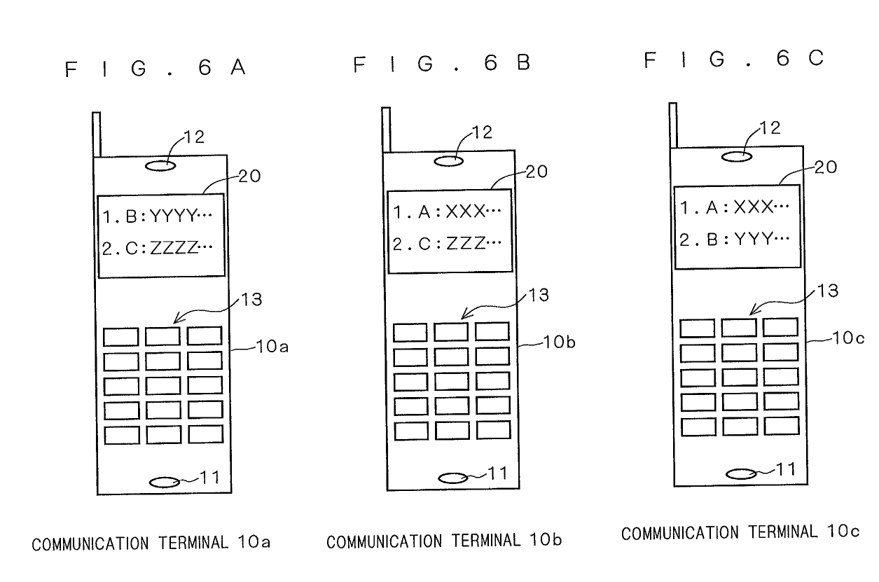

The communication terminal 10 is provided with a microphone 11, a speaker 12, an operation section 13 and a monitor 20 (these constituent parts are shown in FIG. 6A, etc.). The operation section 13 is constituted by key buttons of various types, and through these, for example, a telephone number is inputted at the time when a dial transmission is started, and all the other input operations to the communication terminal 10 are carried out. Moreover, the monitor 20 is used for displaying characters, figures, symbols, etc., inputted through the operation section 13, and also for displaying the date, time and the telephone number of the conversation partner.

Moreover, the communication terminal 10 is provided with a communication control device 14, and the communication control device 14 carries out a controlling operation so as to transmit voice inputted through the microphone 11 to a receiving end, and to output voice received from a transmission end by using the speaker 12.

The communication control device 14 is also provided with a line establishing device 15, an origination information transmitting device 17 and an origination information receiving device 18, and the line establishing device 15 is provided with a line automatic establishing element 16. Here, with respect to the origination information transmitting device 17, the origination information receiving device 18 and the line automatic establishing element 16, explanations thereof will be given in <2. Line automatic establishing means>.

In accordance with receiving end information (dial information) inputted through the operation section 13, the line establishing device 15 carries out a line establishing process in association with a terminal 2, or in accordance with a calling signal transmitted from a terminal 2, it carries out a line establishing process in association with the terminal 2. Here, the line establishing refers to a state in which a one-to-one communication path is established between a terminal on an originator side and a terminal on a recipient side through a communication line, that is, a state in which voice conversation is available between the terminal on the originator side and the terminal on the recipient side.

Then, the line establishing device 15 of the present preferred embodiment is capable of establishing a plurality of lines between a plurality of terminals 2a, 2b through a communication network (telephone communication network) 1. Here, the communication terminals 2 (2a, 2b ), which are communication terminals capable of executing voice conversation, may be assumed as the communication terminal 10 of the present preferred embodiment; however, in this case, any conventional telephone may be used as long as it is provided with conventional functions (that is, a telephone which has, at least, a voice conversation function, and enables a one-to-one line establishment).

More specifically, in a state where one line has been established with one of the terminals 2a, by further inputting receiving end information of another terminal 2b through the operation section 13, a new line is established with another different terminal 2b while the line is being established with the one of the terminals 2a. Alternatively, in a state where one line has been established with one of the terminals 2a, in accordance with a calling signal from another terminal 2b, a new line is established with another different terminal 2b, while the line is being established with the one of the terminals 2a.

In order to establish parallel or simultaneous lines between a plurality of other terminals, a plurality of line modules are installed in the line establishing device 15. These line modules can function individually as well as in a parallel manner. In the case of parallel conversations, a transmission voice signal, generated in response to voice picked up by the microphone 11, is branched and given to a plurality of line modules, and through these modules, it is transmitted to respective conversation ends in a parallel manner. Moreover, received voice signals through the plurality of line modules are multiplexed one after another, and given to the speaker 12.

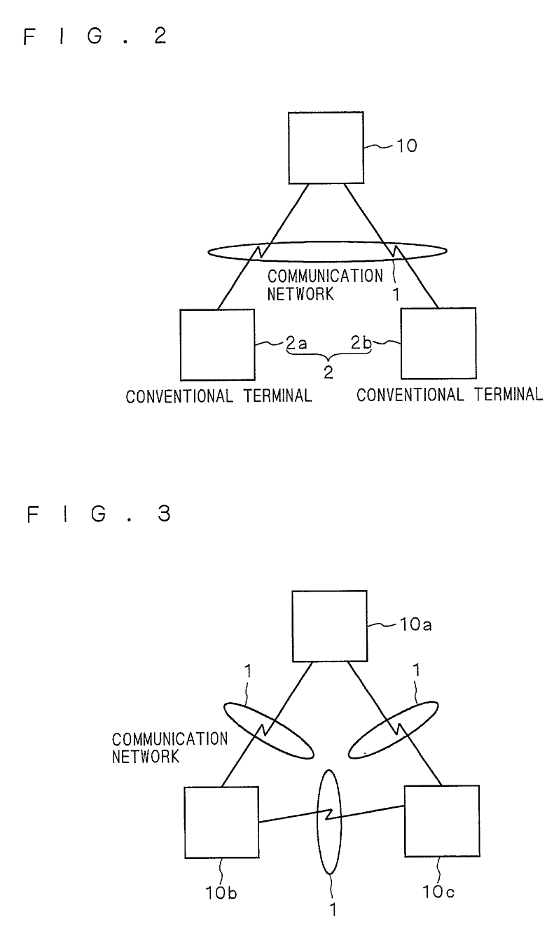

FIG. 2 shows a state in which the communication terminal 10 of the present preferred embodiment has established a plurality of communications together with different terminals 2a, 2b, and the user of the communication terminal 10 is allowed to have conversations with the users of the terminals 2a, 2b, simultaneously by using the single communication terminal 10. In other words, the voice inputted through the microphone 11 of the communication terminal 10 is transmitted to both of the terminals 2a, 2b by the communication control device 14, and voice transmitted from both of the terminals 2a, 2b are received by the communication control device 14, and outputted from the speaker 12.

In this manner, when at least one of a plurality of users who is having conversations uses the communication terminal 10 of the present preferred embodiment, it becomes possible to make parallel or simultaneous conversations in which, for example, the user of the communication terminal 10 makes a conclusion while hearing opinions of both of the users of the terminals 2a, 2b. Moreover, for example, another usage is proposed in which, while the user of the terminal 2a is making a conversation in English, the user of the terminal 2b has a conversation in Japanese, and the user of the communication terminal 10 interprets the conversations of them.

FIG. 3 shows one preferred embodiment in which a plurality of communication terminals 10 (10a, 10b, 10c) have individually established a plurality of lines. In other words, the individual line establishments are made between a communication terminal 10a and a communication terminal 10b, between the communication terminal 10b and a communication terminal 10c, and between the communication terminal 10c and the communication terminal 10a. With this arrangement, the user of the communication terminal 10a is allowed to have conversations with the users of the communication terminals 10b, 10c simultaneously by using the single communication terminal 10a. In the same manner, each of the users of the communication terminals 10b, 10c is allowed to have conversations with the other two users by using the single communication terminal 10b or 10c.

In this manner, each of the users uses the communication terminal 10 of the present preferred embodiment so that it becomes possible to achieve a state in which all the users (three in FIG. 3) gather together to have conversations.

In accordance with the present preferred embodiment, a conversation system related to a plurality of users is achieved by functions provided in the terminals used by the respective users; therefore, no specific function on a network (telephone lines) providing company is required. Moreover, different from a case using a center service, it is not necessary to preliminarily make a registration. Furthermore, with respect to the members that carry out a plurality of conversations, any user can participate as long as he or she uses the communication terminal 10 of the present preferred embodiment; therefore, the group that carry out a plurality of conversations is not limited, and the plurality of conversations can be made among various members.

<2. Line Automatic Establishing Means>

As described above, the communication control device 14 of the communication terminal 10 is provided with the origination information transmitting device 17 and the origination information receiving device 18, and the line establishing device 15 is provided with the line automatic establishing element 16. Moreover, as illustrated in FIG. 1, the communication terminal 10 is provided with an origination information generating device 19.

In the case when a communication terminal 10, which has not participated in conversations by a plurality of users, is allowed to newly participate in the conversations, the origination information generating device 19 generates origination information data 30 related to the communication terminal 10 that is to be newly accepted. The origination information data 30 is data that contains transmission end information (dial information) of the communication terminal 10 that is to be newly accepted, and also includes various pieces of information such as the name and nickname of the user that is to be newly accepted.

The origination information transmitting device 17 is a device for transmitting the generated origination information data 30 to receiving ends that have already established lines. Moreover, the origination information receiving device 18 is a device for receiving the origination information data 30 that has been transmitted thereto.

In this manner, the communication terminal 10 is provided with the origination information receiving device 18 which receives the origination information data 30 to another communication terminal A which has not carried out conversations with the terminal of its own through the other communication terminal B that is making conversations with the terminal of its own, and the line automatic establishing element 16 which, in response to the receipt of the origination information data 30, establishes a line to the communication terminal A without terminating the line with the other receiving terminal B.

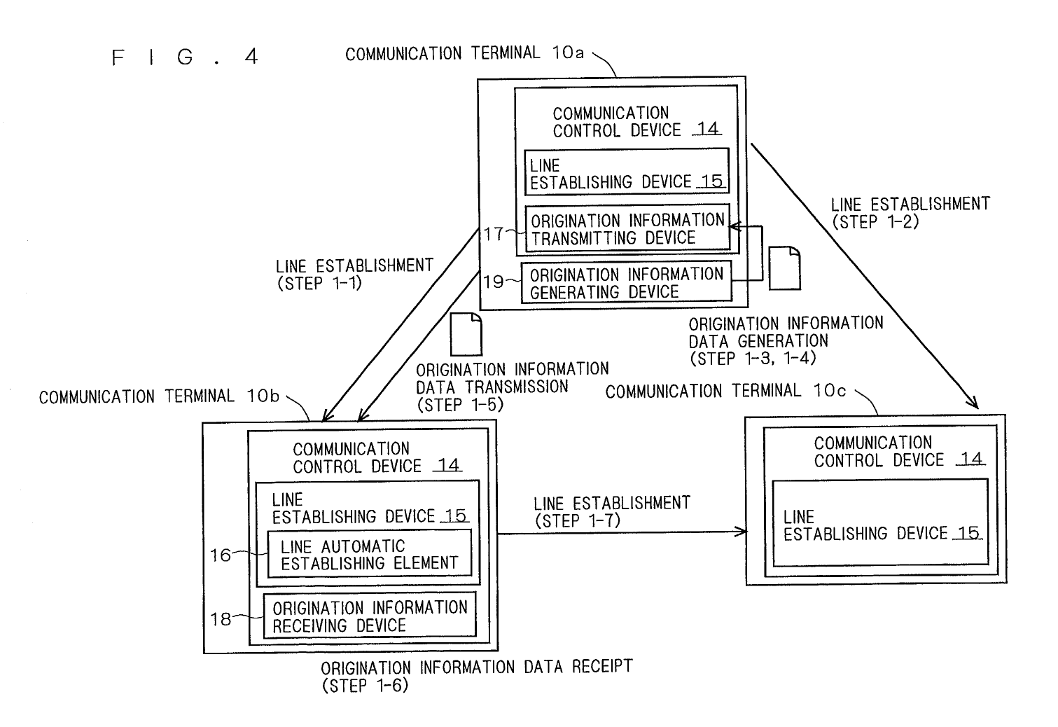

Referring to FIG. 4, an explanation will be given of an automatic establishing process of lines by the communication terminal 10 having the above-mentioned devices. Here, FIG. 4 only shows devices and means of the communication terminal 10 (10a, 10b, 10c) required for the explanation of the automatic establishing process of lines; however, each of the communication terminals 10 has the same functions as that shown in FIG. 1. Therefore, for convenience of explanation, the respective devices and means of each of the communication terminals 10a, 10b, 10c are indicated by the same reference numbers as those of the communication terminal 10.

First, the communication terminal 10a establishes a line to the communication terminal 10b (step 1-1). This allows user A of the communication terminal 10a and user B of the communication terminal 10b to have conversations with each other. Then, if, during the conversations, it is proposed that “user C of the communication terminal 10c should newly participate the conversations”, user A establishes a line to the communication terminal 10c (step 1-2).

Next, in the communication terminal 10a, origination information data 30 is generated by the origination information generating device 19 (step 1-3). The origination information data 30, generated by the origination information generating device 19, contains user information that is to be newly accepted (in this case, the name, dial information, etc. of the user C that is newly accepted); and the setting for the user to be newly accepted is made by key operations through the operation section 13. Upon generation of the origination information data 30 through the inputted instruction by the operation section 13, the origination information generating device 19 transfers the origination information data 30 to the origination information transmitting device 17 (step 1-4). Upon receipt of the origination information data 30, the origination information transmitting device 17 transmits the origination information data 30 to the communication terminal 10b. (step 1-5).

Next, the origination information data 30, transmitted from the origination terminal 10a, is received by the communication information receiving device 18 of the communication terminal 10b (step 1-6). When the origination information receiving device 18 passes the received origination information data 30 to the line establishing device 15, the line automatic establishing element 16 transmits a request for a line establishment to the communication terminal 10c from the communication terminal 10b so that the line establishing device 15 of the communication terminal 10c responds to the calling signal, thereby establishing a line between the communication terminal 10b and the communication terminal 10c (step 1-7). In this manner, in the same manner as the state shown in FIG. 3, it becomes possible to carry out parallel conversations among users A, B and C.

In order to establish parallel or simultaneous lines between a plurality of other terminals, a plurality of line modules are installed in the line establishing device 15. These line modules can function individually as well as in a parallel manner. In the case of parallel conversations, a transmission voice signal, generated in response to voice picked up by the microphone 11, is branched and given to a plurality of line modules, and through these modules, it is transmitted to respective conversation ends in a parallel manner. Moreover, received voice signals through the plurality of line modules are multiplexed one after another, and given to the speaker 12.

With the above-mentioned arrangement, it is not necessary for user B of the communication terminal 10b to carry out operations for establishing a line to the communication terminal 10c. Here, this arrangement is also advantageous in that, even when the user B does not know the telephone number of the communication terminal 10c (user C), the line is automatically established.

FIG. 5 shows another preferred embodiment of a communication automatic establishing process. First, the communication terminal 10a establishes a line to the communication terminal 10b (step 2-1). When it is proposed that user C of the communication terminal 10c should participate in the conversations, user B establishes a line to the communication terminal 10c (step 2-2).

Next, in the communication terminal 10b, origination information data 30 is generated by the origination information generating device 19 (step 2-3), and the origination information data 30 is transferred to the origination information transmitting device 17 (step 2-4). Upon receipt of the origination information data 30, the origination information transmitting device 17 transmits the origination information data 30 to the communication terminal 10a. (step 2-5).

Next, the origination information data 30, transmitted from the communication terminal 10b, is received by the origination information receiving device 18 of the communication terminal 10a (step 2-6). When the origination information receiving device 18 passes the received origination information data 30 to the line establishing device 15, the line automatic establishing element 16 transmits a request for a line establishment to the communication terminal 10c from the communication terminal 10a so that the line establishing device 15 of the communication terminal 10c responds to the calling signal, thereby establishing a line between the communication terminal 10a and the communication terminal 10c (step 2-7). In this manner, in the same manner as the state shown in FIG. 4, it becomes possible to carry out parallel conversations among users A, B and C.

FIGS. 6A, 6B and 6C show display states of the monitors 20 of the communication terminals 10a, 10b, 10c that are used by the respective users A, B, C in a state where conversations are made by these users, as shown in FIG. 4 or FIG. 5.

As illustrated in FIG. 6A, in the monitor 20 of the communication terminal 10a, dial information of the partner is displayed next to the display of the name or nickname of the partner. In other words, the dial information (YYY . . . ) of user B is displayed on the upper stage of the monitor 20, and the dial information (ZZZ . . . ) of user C is displayed on the lower stage of the monitor 20. In the same manner, in the monitor 20 of the communication terminal 10b, information of user A and user C is displayed, and in the monitor 20 of the communication terminal 10c, information of user A and user B is displayed. In this manner, by displaying pieces of information of a plurality of conversation ends on each of the monitors 20, it is possible to readily confirm the members of the group that are currently making conversations.

<3. Secret Conversation Mode Function>

Next, an explanation will be given of a secret conversation mode function that is provided in the communication terminal 10 of the present preferred embodiment. As illustrated in FIG. 1, the communication control device 14 of the communication terminal 10 is provided with a temporary terminating device 21. The temporary terminating device 21 is a device for making a switchover between the connection and disconnection of voice transmitted and received by the communication terminal 10 through the communication control device 14; thus, the temporary terminating device 21 makes it possible to temporarily cutoff the voice transmission and receipt to and from a certain specific communication terminal.

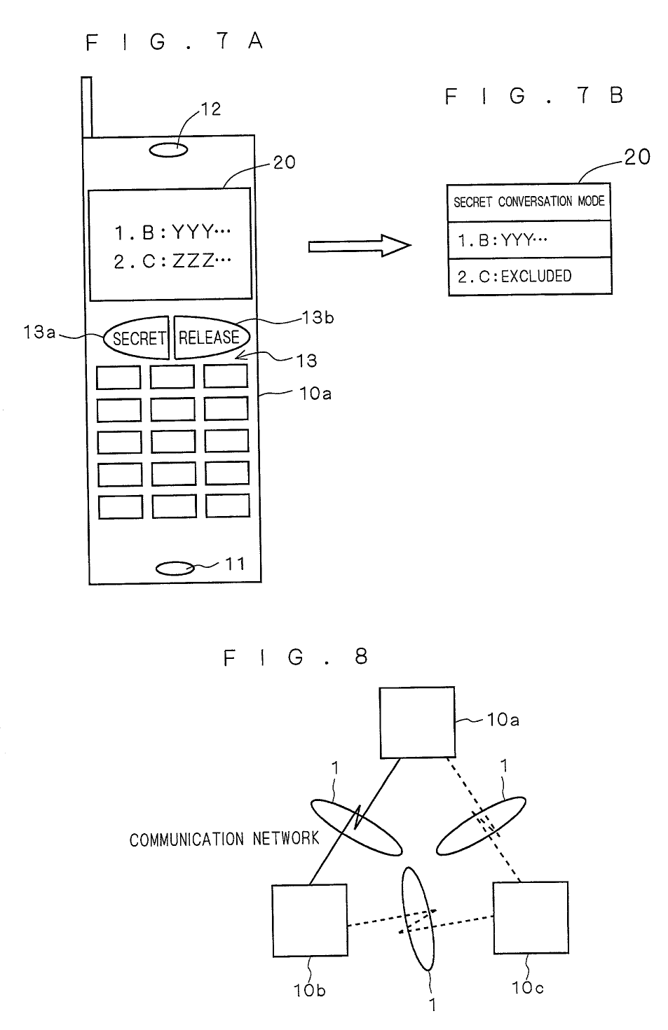

The operation of the temporary terminating device 21 is executed by key inputs made by the user through the operation section 13. As illustrated in FIG. 7A, the operation section 13 of the communication terminal 10(10a) is provided with a secret conversation button 13a for making a switchover to the secret conversation mode and a release button 13b for releasing the secret conversation mode.

As illustrated in FIG. 3, during conversations carried out by the three users A, B, C of the communication terminals 10a, 10b, 10c, if there arises a case in which user A and user B need to discuss only by the two persons, then, after having a consent for the person-to-person discussion from user C, user A and user B respectively press the secret conversation buttons 13a of the respective communication terminals 10a, 10b. In this case, with respect to a selection as to which member is temporarily shut out from the conversation, the selection is made among the participants displayed on the monitor 20 by using the keys of the operation section 13.

FIGS. 7A and 7B show display states of the monitor 20 of the communication terminal 10a. First, FIG. 7A shows a state in which three users are making conversations; therefore, pieces of information of user B and user C are displayed on the monitors 20. Then, with user C being highlighted by the operation of the operation section 13, user A selects the secret conversation button 13a. Consequently, as illustrated in FIG. 7B, the “secret conversation mode” is displayed on the monitor 20, with a character “excluded” is being displayed thereon so as to indicate that user C is currently being shut out from the conversation.

In this manner, a means which visually indicates the communication end (user C in FIG. 7B) among a plurality of communication ends that is being temporarily shut out from the conversation is provided so that it is possible to prevent an erroneous selection as to the person to talk with. In particular, during the secret conversation mode, it is possible to positively prevent the user excluded from the conversation from hearing the contents of the conversation by mistake.

Then, user B of the communication terminal 10b also carries out the same operation so that the character “excluded” is displayed on the monitor 20 of the communication terminal 10b so as to indicate that user C is currently being shut out from the conversation. Thus, as illustrated in FIG. 8, while the respective lines are being established among the communication terminals 10a, 10b and 10c, the line to the communication terminal 10c is brought to a spurious cutoff state. In the Figure, a portion indicated by a broken line shows a state in which the line is in the spurious cutoff state.

By utilizing the function of the above-mentioned secret conversation mode, it is possible to provide various usages while maintaining advantages of conversations by the three users. Moreover, as described above, in the case when a temporary discussion needs to be made by only two persons during the conversations by the three users, the secret conversation mode function is exerted while the line to the excluded communication terminal is being established; therefore, by selecting the releasing button 14b, it is possible to readily return to the original conversations by the three users.

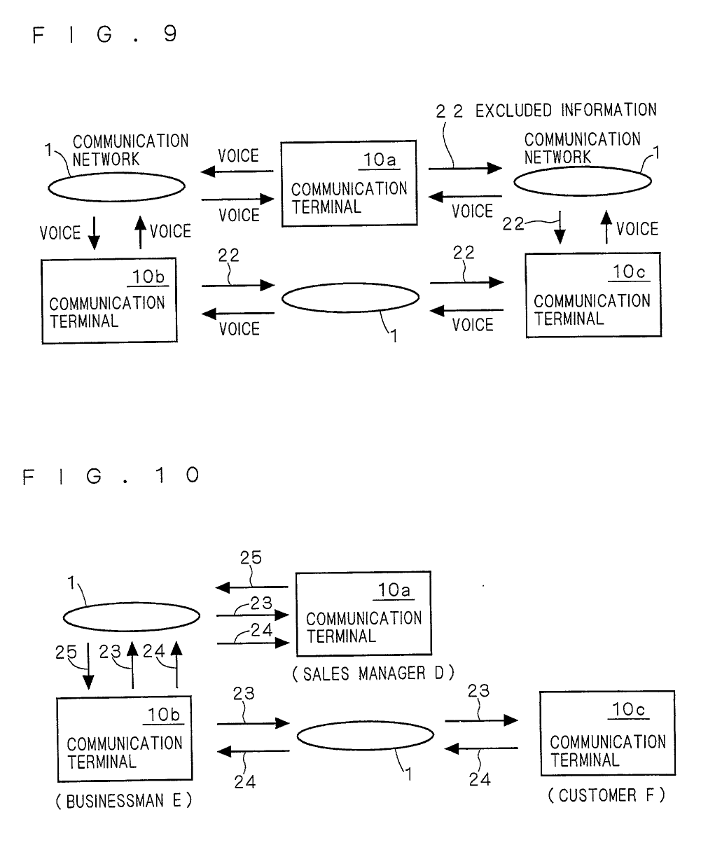

Moreover, by selecting the secret conversation button 13a, only the voice transmission to the user that is excluded may be cut off. In other words, as illustrated in FIG. 9, the temporary terminating device 21 controls in such a manner that the voice from the communication terminals 10a and 10b is not transmitted to the communication terminal 10c, while the voice from the communication terminal 10c is transmitted to the communication terminal 10a and the communication terminal 10b.

In the case when the communication terminal 10a and the communication terminal 10b are switched to the secret conversation mode by which user C is excluded (including both of the modes for temporarily terminating the voice transmission and receipt and for temporarily terminating only the voice transmission), the temporary terminating device 21 is allowed to transmit exclusion information 22 to the communication terminal 10c. Upon receipt of the exclusion information 22, the temporary terminating device 21 of the communication terminal 10c makes a judgment that the communication terminal of its own (the communication terminal 10c) has been excluded, and provides a display indicating this fact on the monitor 20. Thus, user C of the communication terminal 10c is allowed to confirm from the display of the monitor 20 that he or she is being excluded.

In this manner, a means, which, in the case when the communication terminal of its own is temporarily cut off from the voice transmission and receipt as a specified communication end, allows the user of the corresponding communication terminal to recognize the temporary cutoff state, is installed; therefore, it is possible to avoid the problem in which the user of the communication terminal that is being excluded has the mistaken idea that the line is disconnected due to any error in the communication. Here, with respect to the means for indicating the temporary cutoff state, for example, the display on the monitor 20 is used; however, in addition to this, the excluded state may be indicated by voice information or image information.

Moreover, the control may be given so as not to transmit the exclusion information 22 to the communication terminal 10c. In this arrangement, when users A and B of the communication terminal 10a and 10b secretly make the switchover to the secret conversation mode for excluding user C for only a short period of time, users A and B can have a secret conversation without allowing user C to know this fact.

<4. Assisting Mode Function>

Next, an explanation will be given of an assisting mode function. As described earlier, the communication control device 14 of the communication terminal 10 has functions for transmitting voice, inputted through the microphone 11, to a plurality of communication ends whose lines have been established, and for outputting voice, received from the plurality of communication ends, through the speaker 12. Here, the communication control device 14 of the present preferred embodiment is provided with a means for transmitting voice received from a certain specific communication end, as it is, to another specific communication end, that is, a voice relaying device 25.

FIG. 10 shows a state in which a plurality of users (three in the present preferred embodiment) are making conversations by utilizing the voice relaying device 25. As illustrated in the Figure, a line has been established between the communication terminal 10a and the communication terminal 10b, and a line has also been established between the communication terminal 10b and the communication terminal 10c; however, no line is established between the communication terminal 10a and the communication terminal 10c.

In this state, between the users of the communication terminal 10a and the communication terminal 10b as well as between the users of the communication terminal 10b and the communication terminal 10c, it is possible to carry out normal one-to-one conversations. Further, the voice, transmitted from the communication terminal 10c, is outputted from the speaker 12 of the communication terminal 10b, and also transmitted to the communication terminal 10a through the voice relaying device 25 of the communication control device 14. Here, in the Figure, reference number 23 indicates a flow of voice transmitted from the communication terminal 10b, reference number 24 indicates a flow of voice transmitted from the communication terminal 10c, and reference number 25 indicates a flow of voice transmitted from the communication terminal 10a.

With this arrangement, the user of the communication terminal 10c only recognizes that he or she is having conversations with the user of the communication terminal 10b. However, the user of the communication terminal 10b is allowed to hear the voice of the user of the communication terminal 10a, while having conversations with the user of the communication terminal 10c, and the user of the communication terminal 10a is allowed to talk to the user of the communication terminal 10b, while hearing conversations made between the communication terminal 10b and the communication terminal 10c.

In other words, while allowing the basic conversation to progress between the users of the communication terminals 10b and 10c, the user of the communication terminal 10a confirms the contents of the conversation, or if there is any advice based upon the contents of the conversation, he or she can give the advice to the user of the communication terminal 10b.

For example, let us assume that the user (business man E) of the communication terminal 10b and the user (customer F) of the communication terminal 10c are having conversations. The business man E encourages the customer F to buy a product, but it is difficult for the two to reach an agreement with respect to the price. Here, the business man E would like to reach an agreement by giving a discount, but the business man E cannot determine the maximum discount by his own discretion.

In such a circumstance, the assisting mode function of the present preferred embodiment is utilized so that the user of the communication terminal 10a, that is, sales manager D, can give a piece of advice to the business man E. With this arrangement, the business man E becomes free from time-consuming jobs in which, after once hanging up the telephone, he has to telephone the sales manager D so as to confirm the maximum discount, and then again telephone the customer F. In particular, in the case when the business has a time limit, etc., this arrangement is very effective.

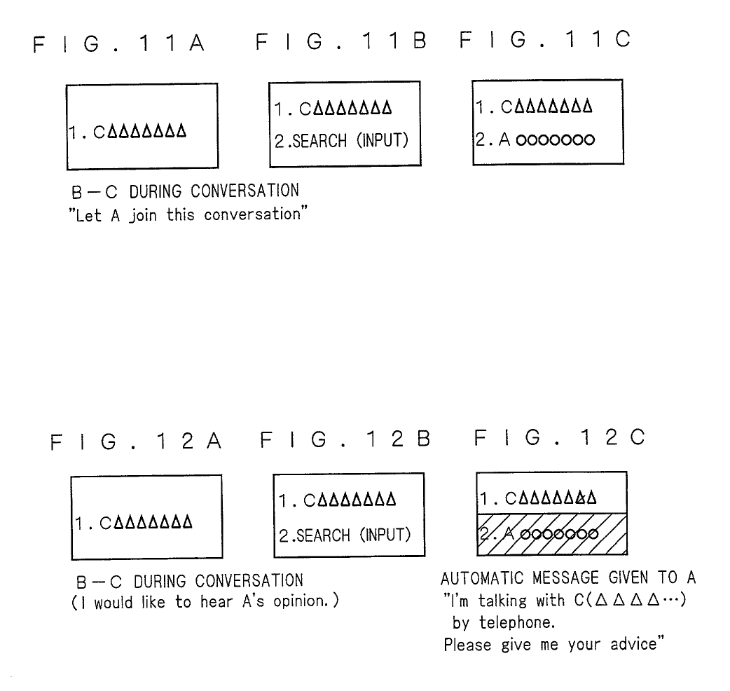

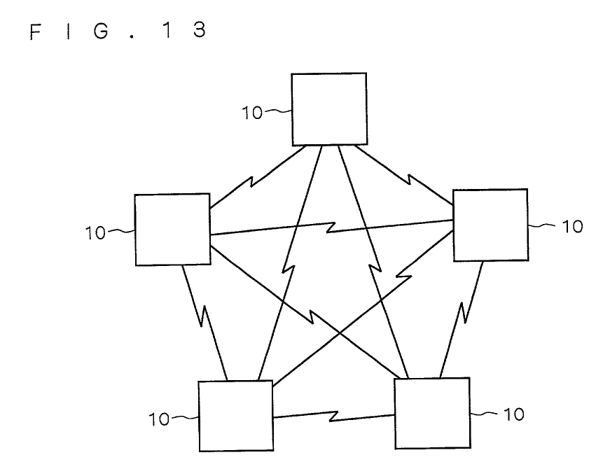

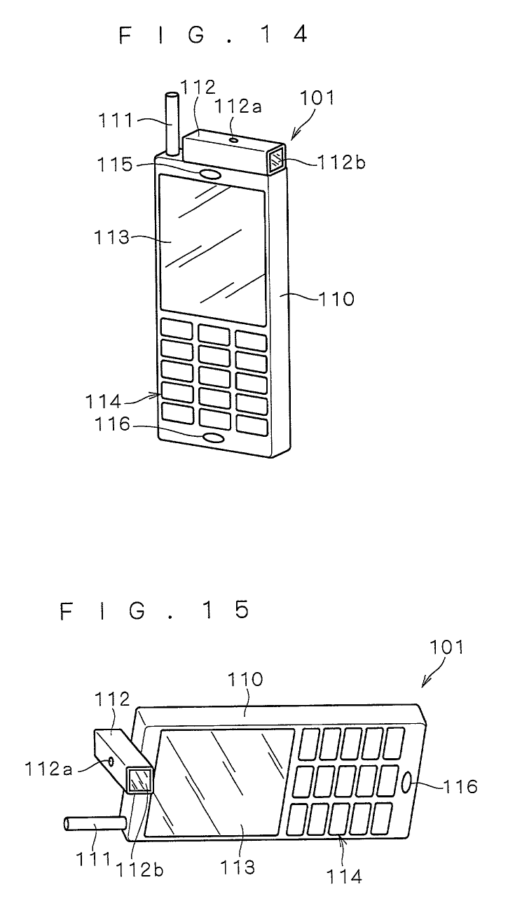

FIGS. 12A, 12B and 12C show the display contents of the monitor 20 at the time when the assisting mode function is operated, and in comparison with FIGS. 11A, 11B and 11C that show the display contents in the case of normal conversations by a plurality of users, an explanation is given of this mode. First, an explanation will be given of FIGS. 11A, 11B and 11C. These Figures show the display contents of the monitor 20 of the communication terminal 10 that is being used by user B, and FIG. 11A shows a state in which user B and user C are having one-to-one conversations with each other.

Next, in the case when user B and user C agree that user A should participate, user B carries out a predetermined operation on the operation section 13, with the result that, as illustrated in FIG. 11B, an input-waiting state for communication end information (telephone number) of the new participant is provided.

Then, user B inputs the communication end information of user A as a new participant so that a line is established between user B and user A; thus, a display shown in FIG. 11C comes on. Thereafter, user C may carry out a line establishing operation to user A in the same manner, or user B may transmit origination information data 30 to user C so as to automatically establish a line.

An explanation will be given of the assisting mode shown in FIGS. 12A, 12B and 12C. FIG. 12A shows a state in which user B and user C are having one-to-one conversations. Next, if user B decides to ask user A for an assistance, user B carries out a predetermined operation on the operation section 13 with the result that, as illustrated in FIG. 12B, an input-waiting state for communication end information (telephone number) of the assistant is provided.

Then, user B inputs the communication end information of user A, that is, the assistant, so that a line is established between user B and user A; thus, a display shown in FIG. 12C comes on. As illustrated in this Figure, for example, meshing is given to the information of user A thus displayed so that it is possible to confirm the state in which the connection is made to user A in the assisting mode.

In this manner, the normal conversation state by a plurality of users and the conversation state in the assisting mode are visually distinguished from each other so that it is possible to use the functions of the respective modes properly without causing confusion to the user.

<5. Modified Example>

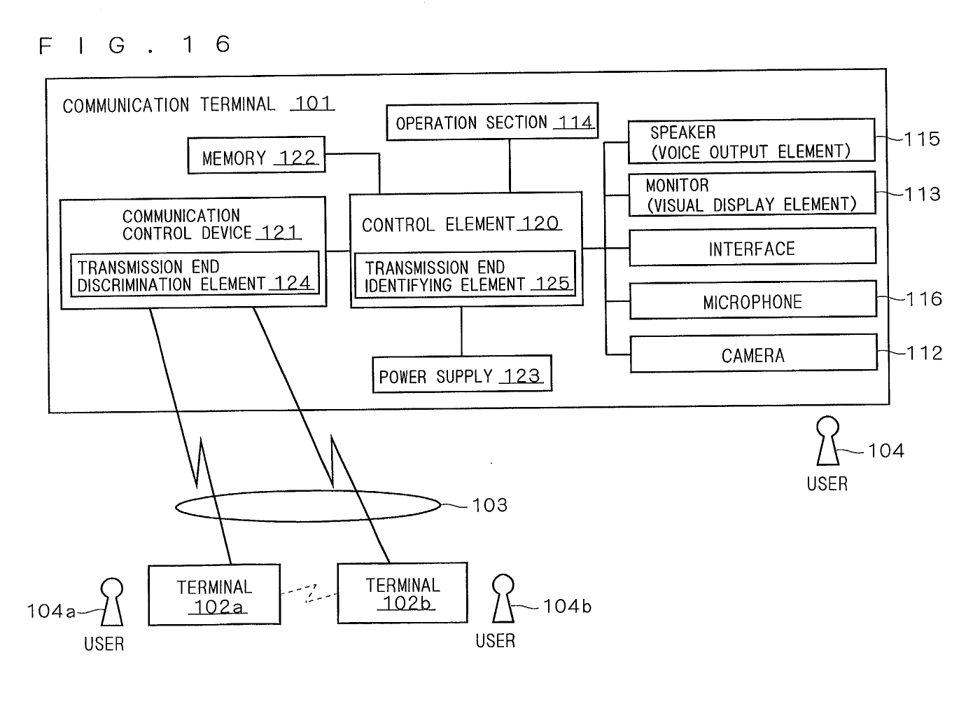

In the above-mentioned preferred embodiment and Figures, explanations have been given of a case of telephone conversations by three users; however, as illustrated in FIG. 13, the application of the communication terminal 10 of the present preferred embodiment allows conversations by users as many as not less than four. Even in the case of many users not less than three, the telephone conversation system by a plurality of users in accordance with the present preferred embodiment is entirely achieved by functions given to the communication terminals; therefore, no specific device is required on a network service company side, and it is possible to provide a system that can be generally used effectively.

### Second Preferred Embodiment

<1. Communication Terminal Enabling Telephone Conversations by a Plurality of Users>

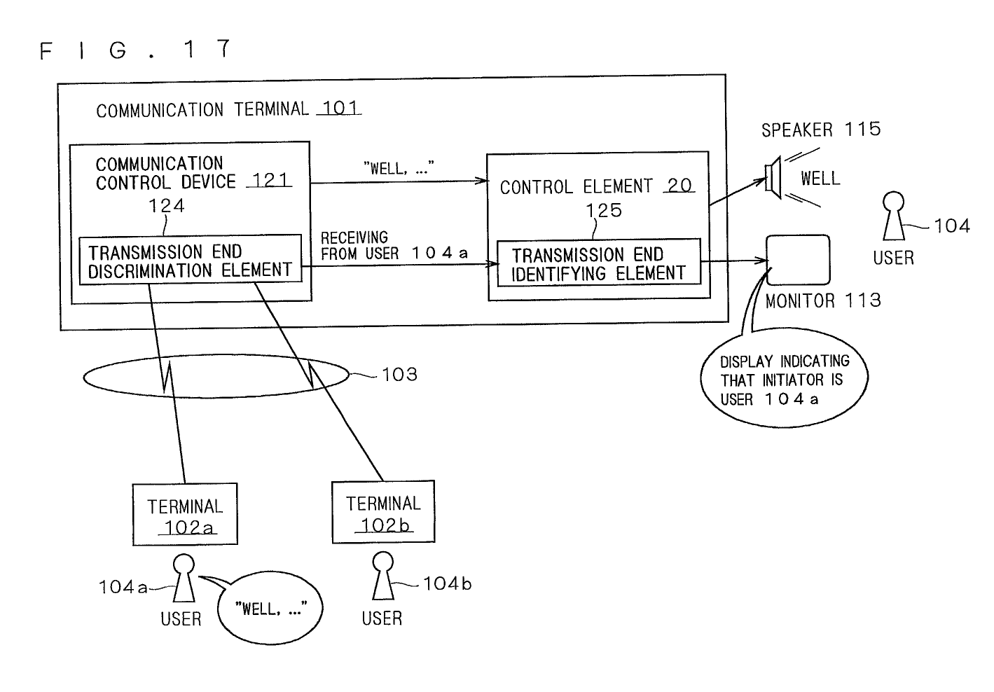

Referring to Figures, the following description will discuss a second preferred embodiment of the present invention. FIG. 14 is a drawing that shows a mobile telephone 101 that is a communication terminal in accordance with the present preferred embodiment, FIG. 14 is a perspective view that shows the mobile telephone 101 placed longitudinally, and FIG. 15 is a perspective view that shows the mobile telephone 101 placed laterally.

As illustrated in FIG. 14 and FIG. 15, the mobile telephone 101 is provided with a terminal main body 110 having a longitudinally elongated shape on the top of which a camera 112 is placed, with an antenna 111 being attached to the side portion of the camera 112. On the front face side of the terminal main body 110, a monitor 113 that serves as a visual display means and an operation section 114 are placed. Moreover, on the upper side of the monitor 113, a speaker 115 that serves as a voice output means is placed, and a microphone 116 is placed on the lower side of the operation section 114.

The camera 112 is attached in a manner so as to freely pivot centered on a support section 112a, and as illustrated in FIG. 15, by rotating the camera 112 to direct a lens 112b on the front face side, the user (the user who uses the mobile telephone 101) is allowed to pick up an image of himself or herself while viewing the display of the monitor 113.

The operation section 114 is constituted by a plurality of keys, and through these, for example, a telephone number is specified, and operations for various functions provided in the mobile telephone 101 are carried out. Moreover, the monitor 113 is used for displaying characters, figures, symbols, etc., inputted through the operation section 114, and also for displaying the telephone number of the conversation partner. Moreover, in the case when the communication terminal of the conversation partner is provided with an image transmitting function, a transmitted image is displayed thereon. In this manner, the mobile telephone 101 of the present preferred embodiment is also provided with functions as a portable visual telephone.

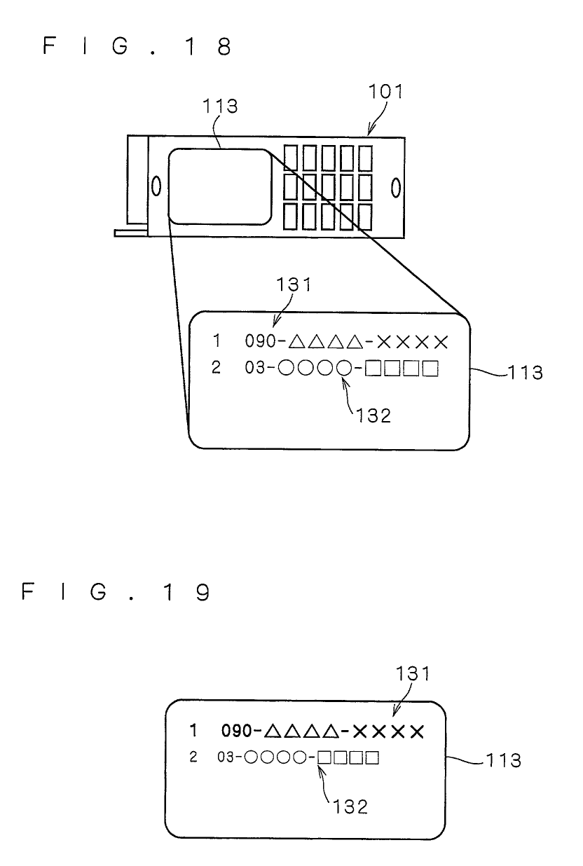

Next, an explanation will be given of an internal structure of the mobile telephone 101. As illustrated in FIG. 16, the mobile telephone 101 is provided with a control element 120, a communication control element 121, a memory 122, a power supply 123, etc., and can be operated by power supplied by the power supply (battery) 123. The control element 120, which forms a central section for carrying out various functions of the mobile telephone 101, transmits voice collected by the microphone 116 and an image picked up by the camera 112 to the communication control element 121, and outputs the voice and image received by the communication control element 121 to the speaker 115 and the monitor 113.

In accordance with communication end information (dial information) inputted through the operation section 114, the communication control element 121 carries out line establishing processes to the other communication terminals, or in response to a calling signal transmitted from another communication terminal, it carries out line establishing processes. Here, the line establishing refers to a state in which a one-to-one communication path is established between a terminal on an originator side and a terminal on a recipient side through a communication line, that is, a state in which voice conversation communication using voice and images is available between the terminal on the originator side and the terminal on the recipient side.

Then, as illustrated in FIG. 16, the communication control element 121 of the present preferred embodiment is capable of establishing a plurality of lines between a plurality of terminals 102a, 102b through a communication network (telephone communication network) 103. Here, the communication terminals 102a, 102b, which are communication terminals capable of carrying out communications using voice and images, may be assumed as the mobile telephone 101 of the present preferred embodiment (a telephone capable of establishing a plurality of lines); however, in this case, any conventional telephone may be used as long as it is provided with conventional functions (that is, a telephone capable of establishing a one-to-one line communication).

More specifically, in a state where one line has been established with one of the terminals 102a, the mobile telephone 101 further inputs receiving end information of another terminal 102b through the operation section 114 so that a new line is established with another different terminal 102b, while the line is being established with the one of the terminals 102a. Alternatively, in a state where one line has been established with one of the terminals 102a, in accordance with a calling signal from another terminal 102b, a new line is established with another different terminal 102b, while the line is being established with the one of the terminals 102a.

In order to establish parallel or simultaneous lines between a plurality of other terminals, a plurality of line modules are installed in the communication control element 121. These line modules can function individually as well as in a parallel manner. In the case of parallel conversations, a transmission voice signal, generated in response to voice picked up by the microphone 116, is branched and given to a plurality of line modules, and through these modules, it is transmitted to respective conversation ends in a parallel manner. Moreover, received voice signals through the plurality of line modules are multiplexed one after another, and given to the speaker 115.

FIG. 16 shows a state in which the mobile telephone 101 of the present preferred embodiment has established a plurality of communications together with different terminals 102a, 102b, and the user 104 of the mobile telephone 101 is allowed to have conversations with the users 104a, 104b of the terminals 102a, 102b, simultaneously by using the single mobile telephone 101. In other words, the voice inputted through the microphone 116 of the mobile telephone 101 is transmitted to both of the terminals 102a, 102b by the communication control element 121, and voice transmitted from both of the terminals 102a, 102b are received by the communication control element 121, and outputted from the speaker 115.

In this manner, when at least one of a plurality of users who is having conversations uses the mobile telephone 101 of the present preferred embodiment, it becomes possible to make parallel or simultaneous conversations in which, for example, the user 104 of the mobile telephone 101 makes a conclusion while hearing opinions of both of the users of the terminals 102a, 102b.

Moreover, in the case when the terminals 102a and 102b are provided with communication control means which enable a plurality of line establishments, in the same manner as the mobile telephone 101 of the present preferred embodiment, it is possible to also establish a line between the terminals 102a and 102b in parallel with each other, as shown in FIG. 16 (indicated by a broken line in the Figure); therefore, each of the users 104, 104a, 104b is allowed to have conversations with the other two users simultaneously.

<2. Transmission End Identifying Means>

As described above, in accordance with the mobile telephone 101 of the present preferred embodiment, it is possible to have conversations with a plurality of users simultaneously, and voice, received from the other terminals 102a, 102b shown in FIG. 16, is outputted from the speaker 115. For this reason, in a state where the user 104a of the terminal 102a and the user 104b of the terminal 102b are alternately having conversations, it is sometimes difficult for the user 104 of the mobile telephone 101 to confirm who is currently having a conversation, in the case when no means for identifying which user is currently having a conversation is provided. Therefore, the mobile telephone 101 of the present preferred embodiment is provided with a transmission end identifying element 125 which allows the user (operator) 104 to visually recognize the transmission end to the mobile telephone 101 of the current conversation.

The transmission end identifying element 125 is provided with a means which, based upon discrimination information of a transmission end discrimination element 124 installed in the communication control element 121, provides a visually identifying display as to the transmission end of the current conversation on the monitor 113 serving as a visually displaying means. Here, the transmission end discrimination element 124 is a means for discriminating the terminal (transmission end) that is currently transmitting voice to the mobile telephone 101 from a plurality of transmission ends whose lines are currently being established by the communication control element 121.

In other words, as described above, the communication control element 121 is provided with a plurality of line modules for establishing parallel or simultaneous lines between other plurality of terminals, and the transmission end discrimination element 124 discriminates which line module is currently receiving voice signal, thereby discriminating the communication end that is currently transmitting the voice.

Based upon the discrimination information of the transmission end discrimination element 124, the transmission end identifying element 125 clearly identifies which partner is currently having a conversation among the partners joining the conversations, that is, provides a visually identifying display of the current transmission end.

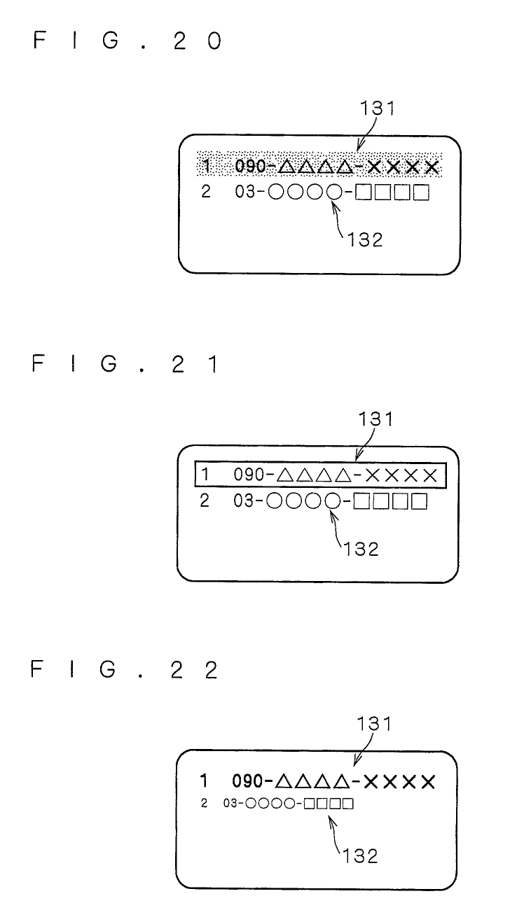

FIG. 17 shows an executing state in the transmission end identifying element 125. For example, when the user 104a of the terminal 102a gives a comment, the voice is transmitted through a communication network 103, and the communication control element 121 receives the voice and the transmission end discrimination element 124 discriminates that the transmission end is the user 104a. Next, the voice is outputted from the speaker 115 through the control element 120, while the transmission end identifying element 125, which has received the discrimination information, clearly informs the user 104 of the transmission end through the monitor 113. Referring to FIGS. 18 through 28, the following description will discuss a preferred embodiment of the transmission end identifying element 125.

<3. Identifying Process by Highlighting Dial Numbers>

FIG. 18 shows a state in which the mobile telephone 101 is placed laterally, with the contents of the display being indicated in an enlarged manner. On the monitor 113, dial numbers of a plurality of different communication ends that are currently having conversations are listed and displayed. Here, the display of the monitor 113 in the Figure shows a state in which lines have been established to the two terminals 102a and 102b shown in FIG. 16, with the users 104a and 104b are having conversations. Here, it is supposed that, in the display, the dial number indicated by “1 090- . . . ” represents dial number 131 of the terminal 102a, and the dial number indicated by “2 03- . . . ” represents dial number 132 of the terminal 102b.

Here, in the case when the user 104a of the terminal 102a gives a comment (transmits voice), based upon the discrimination information of the transmission end discrimination element 124, the transmission end identifying element 125 emphasizes the dial number 131 of the terminal 102a by making the display character thereof thicker, as shown in FIG. 18. Thus, the user 104 of the mobile telephone 101 is allowed to readily confirm that the voice being currently outputted from the speaker 115 is given by the user 104a.

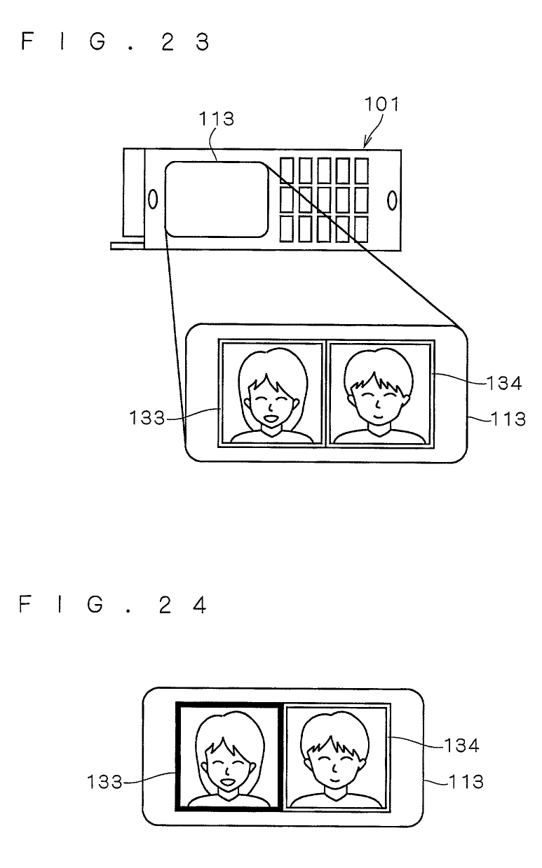

Moreover, with respect to another preferred embodiment for emphasizing the dial number display, as illustrated in FIG. 20, the dial number may be displayed in a meshed manner. In the Figure, the dial number 131 of the terminal 102a is provided as a meshed display, indicating that the user 104a is currently having a conversation.

Furthermore, as illustrated in FIG. 21, an outer frame may be given to the displayed dial number. In the Figure, the dial number 131 of the terminal 102a is displayed with the outer frame, indicating that the user 104a is currently having a conversation.

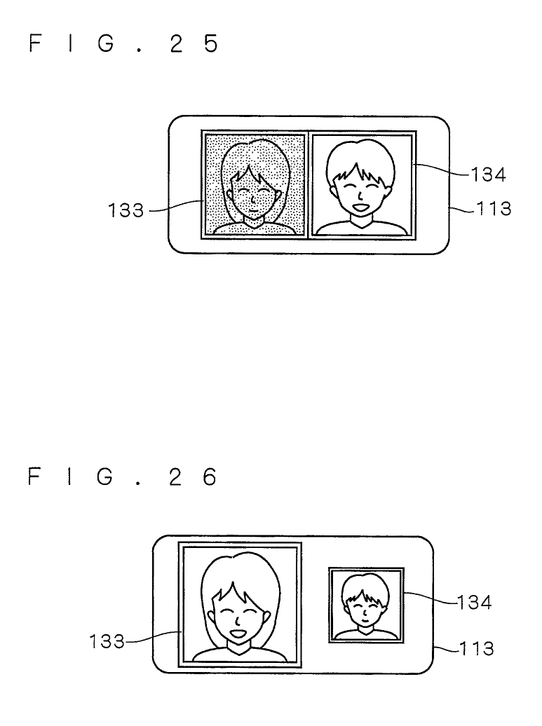

As illustrated in FIG. 22, the dial number may be displayed with a difference in its size. In this Figure, the dial number 131 of the terminal 102a is displayed with a size larger than that of the dial number 132 of the terminal 102b, thereby indicating that the user 104a is currently having a conversation.

As described above, since the transmission end discrimination element 124 and the transmission end identifying element 125 of the present preferred embodiment are realized as functions on the mobile telephone (communication terminal) 101 side; therefore, neither facility investments nor managing costs are required on a network service company side. Moreover, since these functions are not dependent on any system of a network service company, it is possible to provide a structure that has a higher degree of freedom with a better extension property.

<4. Identifying Process by Using Divided Displays on the Monitor>

Next, an explanation will be given of another preferred embodiment of the transmission end identifying element 125. As illustrated in FIG. 23, the display area of the monitor 113 of the mobile telephone 101 is divided into sections, and pieces of guide information are displayed for respectively different communication ends. Here, this Figure shows a display state of the monitor 113 in which lines have been established with respect to the two terminals 102a and 102b, shown in FIG. 16 with conversations being carried out between the users 104a and 104b, and among the divided display areas, a division area 133 gives guide information relating to the terminal 102a, and a division area 134 gives guide information relating to the terminal 102b. Then, as illustrated in the Figure, the respective division areas 133, 134 display images transmitted from the respective terminals 102a, 102b. In other words, the user 104 of the mobile telephone 101 is able to have conversations while looking at the images of the users 104a and 104b of the terminals 102a and 102b, with the mobile telephone 101 being placed laterally.

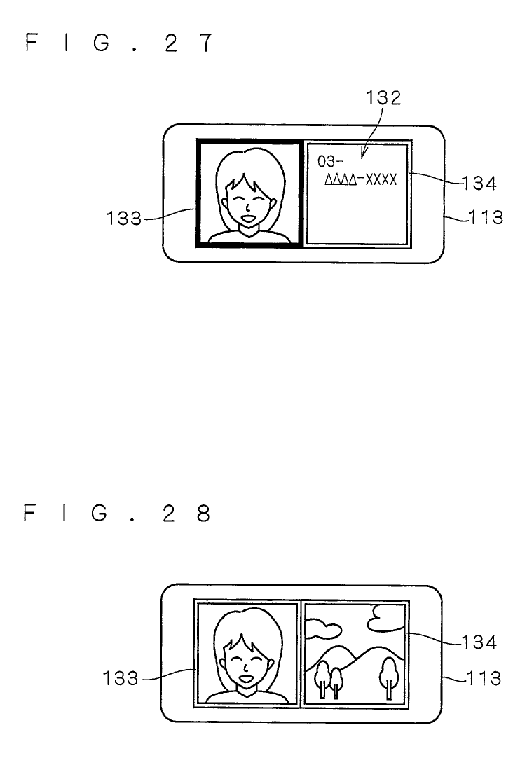

In the case when the user 104a of the terminal 102a gives a comment (transmits voice), based upon discrimination information of the transmission end discrimination element 124, the communication end identifying element 125 displays the divided area 133 displaying the image of the terminal 102a in a manner so as to emphasize the area frame thereof, as shown in FIG. 24. With this arrangement, the user 104 of the mobile telephone 101 is allowed to readily confirm that the voice currently being outputted from the speaker 115 is given by the user 104a.

FIG. 25 shows another preferred embodiment for clearly identifying the transmission end. In the present preferred embodiment, displays are given with a difference in luminance between the division area 134 related to the terminal 102b that is transmitting voice and the division area 133 related to the terminal 102a that is not transmitting voice.

This Figure shows a state in which the user 104b of the terminal 102b is having a conversation, and the luminance of the division area 133 related to the terminal 102a is lowered so that the guide display of the division area 134 related to the terminal 102b is displayed relatively more clearly. Moreover, the luminance of the division area 133 may be lowered with the luminance of the division area 134 being increased.

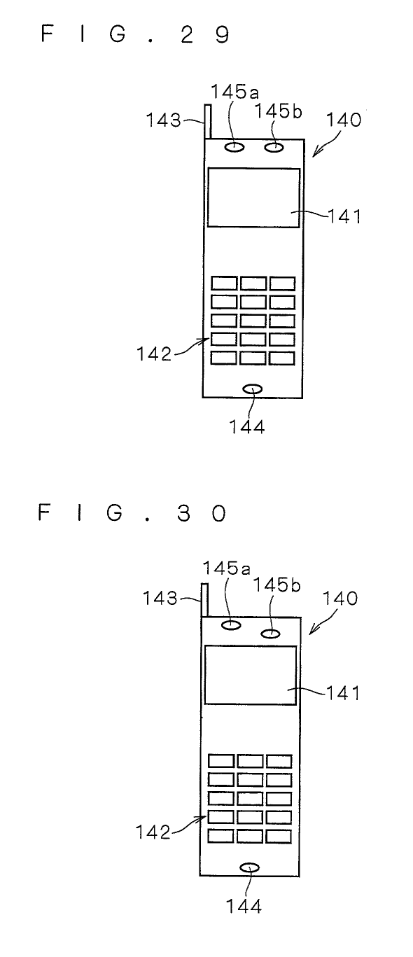

FIG. 26 shows another preferred embodiment for clearly identifying the transmission end. In this preferred embodiment, the division area 133 related to the terminal 102a that is currently transmitting voice is displayed with a size greater than that of the division area 134 related to the terminal 102b that is not transmitting voice. In this Figure, the division area 133 is displayed greater than that of FIG. 23, and the division area 134 is displayed smaller than that of FIG. 23; however, only the division area 133 related to the terminal 102a that is currently transmitting voice may be displayed with a greater size. Alternatively, only the division area 134 related to the terminal 102b that is not transmitting voice may be displayed with a smaller size.

As described above, the division area related to the current transmission end (the terminal that is currently transmitting voice) and the rest of division areas (terminals that are not transmitting voice) are displayed in different display modes by emphasizing the area frames, differentiating the luminance or giving different sizes to the division areas; therefore, the user (operator) 104 is allowed to readily recognize the current transmission end.

As described above, in the preferred embodiments shown in FIGS. 24 through 26, it is assumed that any of the terminals 102a, 102b of the communication ends have a function for transmitting images, and that images have been respectively sent; however, in the case when any one of the communication ends does not transmit an image (including a case without a function for transmitting an image and a case in which no image is sent although the image transmitting function is provided), substituting information may be displayed in the division area related to the corresponding terminal.

FIG. 27 shows the contents of the display of the monitor 113 of the mobile telephone 101 in the same manner. Here, the terminal 102a, which is communicating with the mobile telephone 101, has transmitted an image, and the image of the user 104a of the terminal 102a is displayed on the division area 133 related to the terminal 102a.

Here, the terminal 102b, which is communicating with the mobile telephone 101, does not transmit any image so that the dial number 132 of the terminal 102b is displayed in the division area 134 related to the terminal 102b. In this manner, by displaying the corresponding dial number as the substituting information, pieces of guide information are displayed in a divided manner for the respective communication ends. In the present preferred embodiment also, in the same manner as the preferred embodiments by reference to FIGS. 24 to 26, the area frame is emphasized with respect to the division area related to the terminal on the side that is currently transmitting voice. Alternatively, displays are given with a difference in luminance between the division area in question and the division area related to the terminal that is not transmitting voice. Alternatively, the division area in question is displayed greater than the division area related to the terminal that is not transmitting voice. Thus, it becomes possible to readily recognize the communication end that is currently transmitting voice.

Here, FIG. 27 shows an example in which the division area 133 related to the terminal 102a that is currently transmitting voice is displayed with its frame being emphasized. In addition to this, the division area 134 related to the terminal 102b that is not transmitting voice, that is, the division area 134 displaying the dial number may be displayed in a smaller size, or may be displayed with lower luminance.

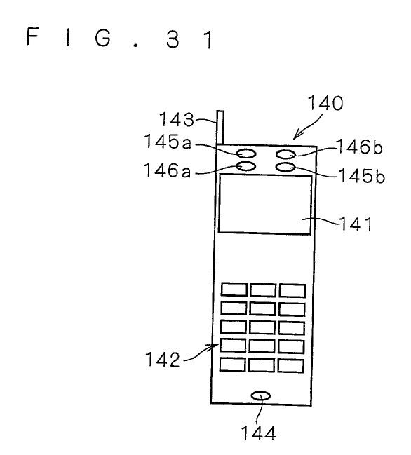

Moreover, in the case when one of terminal of transmission ends does not transmit an image, and when its dial number is not notified, another substituting information may be displayed. FIG. 28 shows a case in which a scenery image (stored in a memory 122) that the mobile telephone 101 owns is given as guide information related to the terminal 102b. Even in such a display of substituting information, as described by reference to FIGS. 24 to 26, the change in the current commentator can be visually confirmed by switching the highlighted display in the area frames, or changing the luminance therein.

In this manner, the pieces of guide information for a plurality of different communication ends are displayed in a substituted manner by using dial numbers, etc.; therefore, even in the case when any of the terminals of transmission ends do not transmit an image (including a case in which some terminals are not provided with a function for transmitting images), the transmission end identifying element 125 allows the user 104 to readily confirm the transmission end that is currently having a conversation.

As described above, the transmission end discrimination element 124 and the transmission end identifying element 125 of the present preferred embodiment are realized as functions on the mobile telephone (communication terminal) 101 side; Moreover, since these functions are not dependent on any system of a network service company, it is possible to provide a structure that has a higher degree of freedom with a better extension property.

<5. Discrimination Using a Plurality of Speakers>

The above-mentioned preferred embodiments have exemplified a case in which voice received from a plurality of different transmission ends is outputted through the speaker 115 that is the same voice output means, and the present preferred embodiment has been devised to solve the problem that it is difficult to discriminate voices of a plurality of users outputted from the same speaker 115. In the next preferred embodiment, a plurality of voice output means are provided so that it becomes possible to easily discriminate different transmission ends.

As illustrated in FIG. 29, a mobile telephone 140, which is a communication terminal of the present preferred embodiment, is provided with a monitor 141 and an operation section 142 on the front face side of a terminal main body, and an antenna 143 on the upper portion of the terminal main body. Further, a microphone 144 is placed on the lower portion of the operation section 142, and speakers 145a, 145b that are two voice output means are placed on the upper portion of the monitor 141.

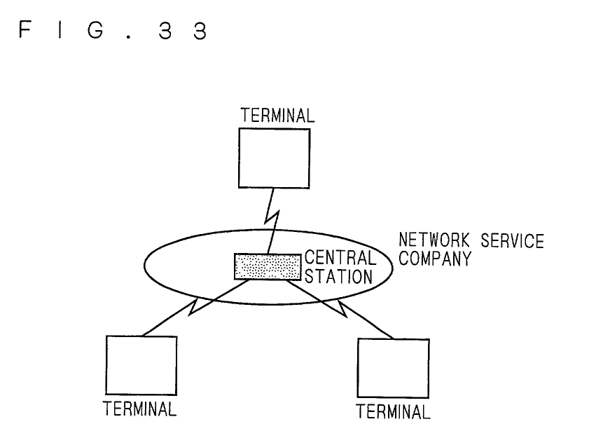

FIG. 32 is a drawing that shows the inner structure of the mobile telephone 140. As illustrated in this Figure, the mobile telephone 140 is provided with a control element 150, a communication control element 151, a memory 152, a power supply 153, etc., and can be operated by power supplied by the power supply (battery) 153. The control element 150 forms a central section for carrying out various functions of the mobile telephone 140.

In the same manner as the communication control element 121 installed in the mobile telephone 101 shown in FIG. 16, etc., the communication control element 151 is capable of establishing lines to a plurality of different communication ends. FIG. 32 shows a state in which the mobile telephone 140 of the present preferred embodiment has established lines to different terminals 106a, 106b through a communication network 107.

Moreover, in the same manner as the transmission end discrimination element 124 installed in the mobile telephone 101 shown in FIG. 16, etc., the transmission end discrimination element 154 is a means for discriminating the communication end that is currently transmitting voice from a plurality of communication ends whose lines are currently being established by the communication control element 151. Here, in the present preferred embodiment, based upon discrimination information of the transmission end discrimination element 154, the different speaker 145a (or 145b) is selected from the speakers 145a and 145b for each of the communication ends, and the selected speaker 145a (or 145b) is used for outputting voice information.

For example, in an example shown in FIG. 32, voice, transmitted from the terminal 106a, is discriminated by the transmission end discrimination element 154 as being transmitted from the terminal 106a, and the transmission end identifying element 155 selects the speaker 145a so as to control the voice to be outputted from the speaker 145a. In contrast, the voice, transmitted from the terminal 106b, is discriminated by the transmission end discrimination element 154 as being transmitted from the terminal 106b, and the transmission end identifying element 155 selects the speaker 145b so as to control the voice to be outputted from the speaker 145b.

By carrying out the above-mentioned controlling operation, the application of the mobile telephone 140 provided with the speakers 145a, 145b as shown in FIG. 29 makes it possible to confirm the transmission end of voice. In other words, the user of the mobile telephone 140 is not allowed to visually confirm who is currently having a conversation, but allowed to hear voice outputted from each of the speakers 145a and 145b, placed physically apart from each other, that are changed depending on the communication ends so that, when the speaking person is switched, the user can easily confirm the change. Thus, it becomes possible to prevent the user from making an erroneous confirmation in which, in spite of the switching of the speaking person, he or she feels as if talking to the same person.

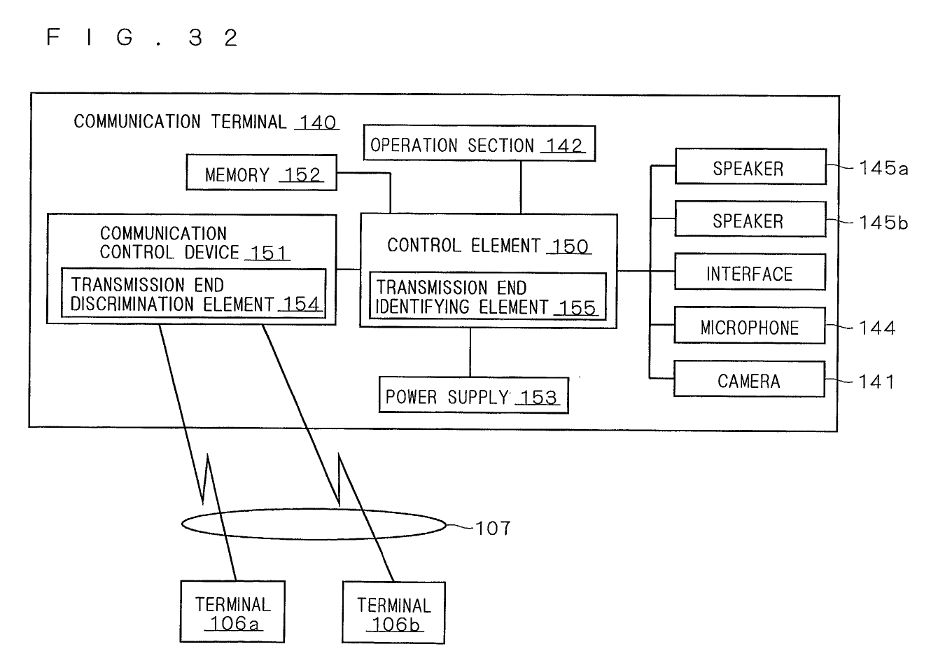

FIG. 30 shows a modified example of the mobile telephone 140 provided with the speakers 145a, 145b. In this preferred embodiment, the speakers 145a, 145b are placed in longitudinally shifted positions from each other. This Figure assumes a case in which the mobile telephone 140 is held by the right hand and put on the right ear, and with the mobile telephone 140 being put on the right ear, the speakers 145a, 145b are aligned virtually in a vertical direction; thus, it becomes possible to hear the outputs of both of the speakers 145a, 145b without any difficulty. In other words, taking into consideration the fact that the human ear has a longitudinally extended shape, the layout of the two speakers 145a, 145b is determined.

Moreover, FIG. 31 shows a case in which four speakers 145a, 145b, 146a, 146b are attached to the mobile telephone 140. In the present preferred embodiment, it is possible to make a selection as to whether the two speakers 145a, 145b are used to respectively output voices from two different conversation ends or the two speakers 146a, 146b are used to respectively output voices from the two different conversation ends.

With this arrangement, in the case when the mobile telephone 140 is held by the right hand and put on the right ear, in the same manner as the case shown in FIG. 30, the speakers 145a, 145b are activated to be used for conversations. Moreover, in the case when the mobile telephone 140 is held by the left hand and put on the left ear, the speakers 146a, 146b are activated to be used for conversations; thus, either of the hands may be used (with the mobile telephone being put on either of the ears) so as to have conversations, it is possible to hear voices from the two speakers 145a, 145b (or 146a, 146b) smoothly without any difficulty. Here, with respect to the switching operation as to which speakers are activated, the speakers 145a, 145b or the speakers 146a, 146b, it may be carried out by the operation section 142.

<6. Modified Example>

In the above-mentioned preferred embodiments, the transmission end discrimination element 124, 154 discriminate the transmission end of voice as communication information; however, in addition to this arrangement, this may be further extended to a mode in which the transmission end of an image is discriminated as communication information. In order to discriminate the transmission end of an image, each of received images from the respective transmission ends is image-analyzed, and with respect to the transmission end that is transmitting an image having movements exceeding a certain criteria, the above-mentioned identifying process of the transmission end may be carried out.

Moreover, in the above-mentioned preferred embodiments, it is assumed that the telephone line is used as a communication network among the terminals; however, another arrangement having the Internet located in between (so-called Internet telephone) may be used. In the arrangement of this type, by using the technology such as VoIP, telephone voice is converted into IP packets, and transmitted through the Internet.

Moreover, the present preferred embodiments may also be applied to an arrangement having no telephone line located in between, that is, a system, such as LAN in companies, and a VPN system utilizing LAN and the Internet. In this case, it is not necessary for the communication control device to establish a plurality of lines, and it is only necessary to make (a single) connection to an IP network, and voice is transmitted and received among a plurality of terminals connected to the IP network. Thus, the transmission end discrimination means makes it possible to discriminate the transmission end of communication information from the transmission end of the IP packets, and based upon this discrimination information, the transmission end identifying means can identify the conversation end that is currently having a conversation.

While the invention has been shown and described in detail, the foregoing description is in all aspects illustrative and not restrictive. It is therefore understood that numerous other modifications and variations can be devised without departing from the scope of the invention.

What is claimed is:

1. A communication terminal, which enables telephone conversations by voice, comprising:
a microphone through which voice is inputted;
a line establishing element that establishes lines to a plurality of terminals on the other side in parallel with each other;
a communication control element for transmitting the voice inputted through said microphone to said plurality of terminals on the other side, and for receiving voice transmitted from said plurality of terminals on the other side; and
a speaker for outputting the voice received by said communication control element.

2. A conversation system, which enables telephone conversations by voice among a plurality of communication terminals, at least one of said communication terminals comprising:
a microphone through which voice is inputted;
a line establishing element that establishes lines to a plurality of terminals on the other side in parallel with each other;
a communication control element for transmitting the voice inputted through said microphone to said plurality of terminals on the other side, and for receiving the voice transmitted from said plurality of terminals on the other side; and
a speaker for outputting voice received by said communication control element.

3. A conversation system, which enables telephone conversations by voice among a plurality of communication terminals, each of said communication terminals comprising:
a microphone through which voice is inputted;
a line establishing element that establishes lines to a plurality of terminals on the other side in parallel with each other;
a communication control element for transmitting the voice inputted through said microphone to said plurality of terminals on the other side, and for receiving said voice transmitted from said plurality of terminals on the other side; and
a speaker for outputting voice received by said communication control element.

4. The conversation system according to claim 3, wherein a first communication terminal of said plurality of communication terminals comprises:
an origination information generating element for generating origination information data related to a second communication terminal whose line has not been established to a third communication terminal; and
an origination information transmitting element for transmitting the origination information data, generated by said origination information generating element to said third communication terminal whose line has been established to said first communication terminal,
said third communication terminal comprises:
an origination information receiving element for receiving the origination information data transmitted by said first communication terminal, and
the line establishing element of said third communication terminal comprises:
a line automatic establishing element which, based upon the origination information data received by said origination information receiving element, establishes a line to said second communication terminal without terminating the line to said first communication terminal.

5. A line establishing method used in a conversation system, which enables telephone conversations by voice among a plurality of communication terminals, wherein each of said communication terminals comprises:
a microphone through which voice is inputted;
a line establishing element that establishes lines to a plurality of terminals on the other side in parallel with each other;
a communication control element for transmitting the voice inputted through said microphone to said plurality of terminals on the other side, and for receiving said voice transmitted from said plurality of terminals on the other side; and
a speaker for outputting voice received by said communication control element,
a first communication terminal of said plurality of communication terminals comprises:
an origination information generating element for generating origination information data related to a second communication terminal whose line has not been established to a third communication terminal; and
an origination information transmitting element for transmitting the origination information data, generated by said origination information generating element to said third communication terminal whose line has been established to said first communication terminal,
said third communication terminal comprises:
an origination information receiving element for receiving the origination information data transmitted by said first communication terminal, and
the line establishing element of said third communication terminal comprises:
a line automatic establishing element which, based upon the origination information data received by said origination information receiving element, establishes a line to said second communication terminal without terminating the line to said first communication terminal, and
said line establishing method comprising first to fourth steps, wherein
1) said first communication terminal establishes a line to said third communication terminal in said first step;
2) said first communication terminal establishes a line to said second communication terminal in said second step;
3) said first communication terminal transmits said origination information data to said third communication terminal in said third step; and
4) said third communication terminal establishes a line to said second communication terminal by using said line automatic establishing element, thereby allowing the lines to be mutually established among said first, second, and third communication terminals in said fourth step.

6. A communication terminal, which enables telephone conversations by voice, comprising:
an origination information receiving element for receiving origination information data related to another communication terminal A that is not having conversations with said terminal in question from still another communication terminal B that is currently having conversations with said terminal in question; and
a line automatic establishing element which, in response to receipt of said origination information data, establishes a line to said communication terminal A without terminating the line to said receiving terminal B.

7. The communication terminal according to claim 6, further comprising:
an origination information generating element for generating origination information data related to another communication terminal C; and
an origination information transmitting element for transmitting the origination information data related to said communication terminal C, generated by said origination information generating element, to still another communication terminal B that is having conversations with said terminal in question, but is not having conversations with said communication terminal C.

8. A conversation system, which enables telephone conversations by voice among a plurality of communication terminals, each of said communication terminals comprising:
an origination information receiving element for receiving origination information data related to another communication terminal A that is not having conversations with the terminal in question from still another communication terminal B that is currently having conversations with the terminal in question;
a line automatic establishing element which, in response to receipt of said origination information data, establishes a line to said communication terminal A without terminating the line to said receiving terminal B;
an origination information generating element for generating origination information data related to still another communication terminal C; and
an origination information transmitting element for transmitting the origination information data related to said communication terminal C, generated by said origination information generating element, to still another communication terminal B that is having conversations with the terminal in question, but is not having conversations with said communication terminal C.

9. The communication terminal according to claim 7, further comprising:
a temporary terminating element for temporarily terminating a voice transmission and receipt to and from a specified terminal on the other side among a plurality of terminals on the other side whose lines have been established.

10. The communication terminal according to claim 7, further comprising:
a temporary terminating element for temporarily terminating a voice transmission to a specified terminal on the other side among a plurality of terminals on the other side whose lines have been established.

11. The communication terminal according to claim 9, wherein said temporary terminating element further comprises:
an element for allowing the user to visually recognize the terminal on the other side that has been specified so as to be temporarily terminated among the plurality of terminals on the other side.

12. The communication terminal according to claim 9, wherein said temporary terminating element further comprises:
an element which, when temporarily terminated as the specified terminal on the other side, allows the user thereof to recognize the temporary terminated state.

13. The communication terminal according to claim 7, further comprising:
a voice relaying element which relays and transmits voice received from a specified terminal on the other side among the plurality of terminals on the other side whose lines have been established, as it is, to another specified terminal on the other side.

14. A communication terminal comprising:
a communication control element which establishes lines to a plurality of different terminals on the other side in parallel with each other; and
a transmission end identifying element which allows an operator of said communication terminal to visually recognize the current transmission end to said communication terminal by reflecting the result of discrimination as to which terminal of said plurality different terminals on the other side is currently transmitting communication information to said communication terminal to a display state of a visual displaying element installed on said communication terminal.

15. The communication terminal according to claim 14, wherein said communication information comprises a voice signal, and said communication control element comprises:
a transmission end discrimination element for discriminating which terminal of said plurality of different terminals on the other side has transmitted said received voice signal, and
said transmission end identifying element includes:
an element for allowing said visual displaying element to provide said visually discriminating display of said current transmission end, based upon discrimination information of said transmission end discrimination element.

16. The communication terminal according to claim 15, further comprising:
an element for displaying a list of dial numbers of said plurality of different terminals on the other side on said visual displaying element,
wherein said transmission end identifying element includes:
an element for displaying a dial number of said current transmission end in an emphasized manner from the dial numbers of said plurality of different terminals on the other side displayed on said visual displaying element.

17. The communication terminal according to claim 15, further comprising:
an element for dividing a display area of said visual displaying element into a plurality of division areas and for displaying guide information on each of said division areas for each of said plurality of different terminals on the other side,
wherein said transmission end identifying element includes:
an element for displaying said division area corresponding to said current transmission end in a display mode different from the rest of said division areas with respect to said plurality of division areas,

18. The communication terminal according to claim 17, wherein said transmission end identifying element includes:
an element for displaying a frame of said division area corresponding to said current transmission end in an emphasized manner from the rest of said division areas with respect to said plurality of division areas.

19. The communication terminal according to claim 17, wherein said transmission end identifying element includes:
an element for displaying said division area corresponding to said current transmission end with an increase in luminance from the rest of said division areas with respect to said plurality of division areas.

20. The communication terminal according to claim 17, wherein said transmission end identifying element includes:
an element for displaying said division area corresponding to said current transmission end in an enlarged manner from the rest of said division areas with respect to said plurality of division areas.

21. The communication terminal according to claim 17, wherein said communication control element further comprises:
an image receiving element for receiving an image transmitted from each of said plurality of different terminals on the other side, and
said visual displaying element is allowed to display the image that is currently being received, by said communication control element.

22. The communication terminal according to claim 21, wherein said guide information is an image received from each of said plurality of different terminals on the other side.

23. The communication terminal according to claim 21, wherein, among said plurality of different terminals on the other side, with respect to those terminals on the other side that have transmitted images, received images from the terminals on the other side are displayed as said guide information, while among said plurality of different terminals on the other side, with respect to those terminals on the other side that transmit no images, substituting information for identifying the terminals on the other side are displayed as said guide information.

24. A communication terminal comprising:
a communication control element which establishes lines to a plurality of different terminals on the other side in parallel with each other,
wherein said communication control element comprises:
a transmission end discriminating element for discriminating which terminal of said plurality of different terminals on the other side is currently transmitting voice information to said communication terminal,
said communication terminal further comprising:
a transmission end identifying element which, based upon discrimination information of said transmission end discriminating element, selects a different voice output element for each terminal on the other side from a plurality of voice output elements installed in said communication terminal, and which outputs said voice information from the selected voice output element so that the operator of said communication terminal is allowed to clearly recognize the current transmission end to said communication terminal.
